(19) United States
(12) Patent Application Publication
(10) Pub. No.: US 2025/0170713 A1
(43) Pub. Date: May 29, 2025

(54) WORK SPACE FORCE/ACCELERATION DISTURBANCE OBSERVER AND ROBOT INCLUDING THE SAME

(71) Applicants: NAU ROBOTICS CO., LTD, Incheon (KR); DAEGU GYEONGBUK INSTITUTE OF SCIENCE AND TECHNOLOGY, Daegu (KR)

(72) Inventors: Sehoon OH, Daegu (KR); Wonbum YUN, Daegu (KR); Wooseok HAN, Daegu (KR); Bumgil KIM, Incheon (KR); Kunkook LEE, Incheon (KR)

(73) Assignees: NAU ROBOTICS CO., LTD, Incheon (KR); DAEGU GYEONGBUK INSTITUTE OF SCIENCE AND TECHNOLOGY, Daegu (KR)

(21) Appl. No.: 18/442,544

(22) Filed: Feb. 15, 2024

(30) Foreign Application Priority Data
Nov. 24, 2023 (KR) 10-2023-0166024

(51) Int. Cl. B25J 9/16; B25J 13/08

(52) U.S. Cl. CPC B25J 9/1653; B25J 9/1633; B25J 9/1664; B25J 13/085

(57) ABSTRACT

The present disclosure relates to a work space force/acceleration disturbance observer and a robot including the same. The work space force/acceleration disturbance observer is connected to an impedance-based motion controller in a work space. The work space force/acceleration disturbance acquires a disturbance estimate value in consideration of an interactive force and an acceleration applied to an end effector of a robot. The disturbance estimate value is expressed in Equation 1: \hat{D}=Q(−F′_{c}+Mₒ\ddot{x}+Fₑₓₜ) wherein \hat{D} is the disturbance estimate value, “Q” is a “Q” filter, F′_{c} is a control input force, \hat{M}ₒ is a mass matrix estimate value, \ddot{x} is the acceleration, and Fₑₓₜ is the interactive force.

### CROSS-REFERENCE TO RELATED APPLICATIONS

A claim for priority under 35 U.S.C. § 119 is made to Korean Patent Application No. 10-2023-0166024 filed on Nov. 24, 2023, in the Korean Intellectual Property Office, the entire contents of which are hereby incorporated by reference.

### BACKGROUND

Embodiments of the inventive concept described herein relate to a work space force/acceleration disturbance observer, and a robot including the same.

An impedance control is used in various application fields that require both position tracking and following upon contact. However, disturbances, such as frictions and a model uncertainty have a negative influence on a performance of an impedance-based motion control. To solve this problem, disturbance observers, which remove disturbances observed in a nominal model, are widely used.

### SUMMARY

The inventive concept provides a work space force/acceleration disturbance observer that observes a disturbance by utilizing both an interactive force and an acceleration, and a robot including the same.

The technical objects of the inventive concept are not limited to the above-mentioned ones, and the other unmentioned technical objects will become apparent to those skilled in the art from the following description.

According to an aspect of the inventive concept, there is provided a work space force/acceleration disturbance observer connected to an impedance-based motion controller in a work space, and that acquires a disturbance estimate value in consideration of an interactive force and an acceleration applied to an end effector of a robot, and the disturbance estimate value is expressed in the following equation,

$$\hat{D} = Q ( - {F}_{c}^{′} + {\hat{M}}_{O} \ddot{x} + {F}_{ext} ) \qquad [ Equation ]$$

wherein \hat{D} is the disturbance estimate value, “Q” is a “Q” filter, F′_{c} is a control input force, \hat{M}ₒ is a mass matrix estimate value, \ddot{x} is the acceleration, and Fₑₓₜ is the interactive force.

According to another aspect of the inventive concept, a robot for performing an impedance-based motion control in a work space includes a robot manipulator; and a robot controller connected to the robot manipulator, wherein the robot controller includes an impedance-based motion controller, and a work space force/acceleration disturbance observer connected to the impedance-based motion controller, the work space force/acceleration disturbance observer acquires a disturbance estimate value in consideration of an interactive force and acceleration applied to an end effector of the robot, and the disturbance estimate value is expressed in the following equation,

$$\hat{D} = Q ( - {F}_{c}^{′} + {\hat{M}}_{O} \ddot{x} + {F}_{ext} ) \qquad [ Equation ]$$

wherein \hat{D} is a disturbance estimate value, “Q” is a “Q” filter, F_{c}′ is a control input force, \hat{M}ₒ is a mass matrix estimate value, \ddot{x} is the acceleration, and Fₑₓₜ is the interactive force.

The other detailed items of the inventive concept are described and illustrated in the specification and the drawings.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a view schematically illustrating a robot control system including a work space force/acceleration disturbance observer according to an embodiment of the inventive concept;

FIG. 2 is a view schematically illustrating a robot including a work space force/acceleration disturbance observer according to another embodiment of the inventive concept;

FIGS. 3A and 3B are views schematically illustrating performances of the robot of FIG. 2 in the free motion space; and

FIGS. 4A and 4B are views schematically illustrating performances of the robot of FIG. 2 in a contact motion space.

### DETAILED DESCRIPTION

The above and other aspects, features and advantages of the invention will become apparent from the following description of the following embodiments given in conjunction with the accompanying drawings. However, the inventive concept is not limited to the embodiments disclosed below, but may be implemented in various forms. The embodiments of the inventive concept are provided to make the disclosure of the inventive concept complete and fully inform those skilled in the art to which the inventive concept pertains of the scope of the inventive concept.

The terms used herein are provided to describe the embodiments but not to limit the inventive concept. In the specification, the singular forms include plural forms unless particularly mentioned. The terms “comprises” and/or “comprising” used herein does not exclude presence or addition of one or more other elements, in addition to the aforementioned elements. Throughout the specification, the same reference numerals dente the same elements, and “and/or” includes the respective elements and all combinations of the elements. Although “first”, “second” and the like are used to describe various elements, the elements are not limited by the terms. The terms are used simply to distinguish one element from other elements. Accordingly, it is apparent that a first element mentioned in the following may be a second element without departing from the spirit of the inventive concept.

Unless otherwise defined, all terms (including technical and scientific terms) used herein have the same meaning as commonly understood by those skilled in the art to which the inventive concept pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

Hereinafter, exemplary embodiments of the inventive concept will be described in detail with reference to the accompanying drawings.

In the specification, “dynamics” is used instead of a simplified expression of a dynamic model, a dynamic model equation or a dynamic equation, or an equation of motion, and the like. For the purpose of simplification, a notation and/or meaning of “vector” or “matrix” is omitted in relation to some items in some mathematical equations.

Impedance control is widely used in contact-based application fields. An impedance controller determines a force against an external force through a rendered impedance and is used for tasks that require tracking motions.

However, disturbances, such as a friction and a model uncertainty, are unavoidable problems when multi-link manipulators are controlled, and degrade a performance of an impedance-based motion control. Although disturbances may be suppressed through feedback controls using a high impedance or a feedback gain, an impedance has to be designed in consideration of a contact between the robot and an environment to prevent a breakage or damage to the robot.

Disturbance observers are widely used to remove disturbances from a nominal model. Disturbance observers have been used to control single input single output (SISO) systems that require robustness. However, conventional disturbance observers are unsuitable for interactive force controls in contact situations.

In interactive tasks of humans and robots, it is necessary to ensure safety against unintentional contacts of humans and robots. To achieve both accurate motion control and safe operation in contact situations, an impedance-based robust motion controller is needed.

The work space force/acceleration disturbance observer described below may effectively eliminate a disturbance for a precise motion control and a safe contact operation. Work space force/acceleration disturbance observers may be used in a design of a low impedance-based motion controller.

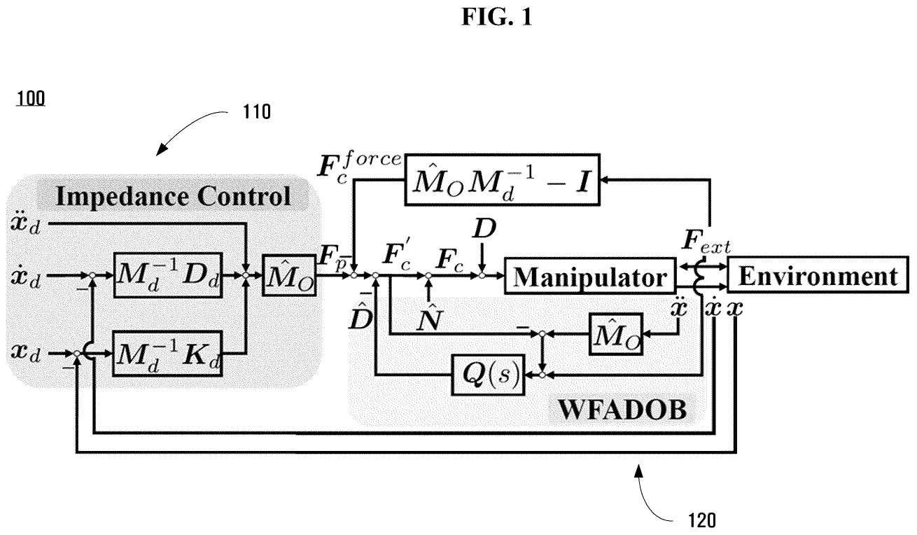

FIG. 1 is a view schematically illustrating a robot control system including a work space force/acceleration disturbance observer according to an embodiment of the inventive concept.

Referring to FIG. 1, a robot control system 100 includes an impedance-based motion controller 110 (Impedance Control) and a work space force/acceleration disturbance observer 120 (WFADOB).

The impedance-based motion controller 110 controls a motion of the robot based on impedance. The impedance-based motion controller 110 generates an impedance target value for the applied force.

The dynamics of a manipulator with a degree of freedom of n (n is a natural number greater than or equal to 1) in a joint space may be expressed in Equation 1 below.

$$M ( q ) \ddot{q} + C ( q , \dot{q} ) + G ( q ) + {τ}_{f} = {τ}_{c} - {J}^{T} ( q ) {F}_{ext} \qquad [ Equation 1 ]$$

Here, “Q” represents a joint position, \dot{q} represents an angular velocity, \ddot{q} represents an angular acceleration, M(q) represents an inertia matrix, C(q, \dot{q}) represents a Coriolis matrix, and G(q) represents a gravitational force vector, τ_{f} represents a frictional torque vector, τ_{c} represents a control torque vector, J(q) represents a Jacobian matrix, and Fₑₓₜ represents an external force (i.e., an interactive force) applied to an end effector of the robot in the Cartesian space (coordinate system).

Based on this, when the dynamics of the end effector are obtained in the Cartesian space, it may be expressed in Equation 2 below.

$${M}_{O} ( q ) \ddot{x} + N ( q , \dot{q} ) + {F}_{f} = {F}_{c} - {F}_{ext} \qquad [ Equation 2 ]$$

Here, x represents a position, \dot{x} represents a velocity, and \ddot{x} represents an acceleration.

Here, Mₒ(q) represents the Cartesian inertia matrix (mass matrix), F_{f} represents the frictional force vector, F_{c} represents the control input force vector, and N(q, \dot{q}) represents other non-linear items, respectively, and they may be expressed in Equation 3 below.

$${M}_{O} ( q ) = {J}^{- T} {MJ}^{- 1} , \\ {F}_{f} = {J}^{- T} {τ}_{f} , \\ {F}_{c} = {J}^{- T} {τ}_{c} , \\ N ( q , \dot{q} ) = {J}^{- T} ( C - {MJ}^{- 1} J \dot{q} ) + {J}^{- T} G ( q ) \qquad [ Equation 3 ]$$

When there is no disturbance observer, the Cartesian coordinate system control input force F_{c} output by the impedance-based motion controller 110 may be expressed in Equation 4 below. The target values of a position x, a velocity \dot{x}, and an acceleration \ddot{x} may be acquired through target error dynamics.

$${F}_{c} = {F}_{p} + \hat{N} ( q , \dot{q} ) - {F}_{c}^{force} , \\ {F}_{c}^{force} = ( {\hat{M}}_{O} {M}_{d}^{- 1} - 1 ) {F}_{ext} \qquad [ Equation 4 ]$$

Here, Fₚ represents an impedance-based motion control input, \hat{N}(q, \dot{q}) represents an estimate value of another non-linear item including a Coriolis force and a gravitational force, F_{c}^{force} represents an external force, \hat{M}ₒ represents a mass matrix estimate value, M_{d} represents a mass target value, and Fₑₓₜ represents an interactive force.

To determine the influences of the disturbances, such as a friction and an uncertainty that interfere with the impedance control, Equation 4 above may be replaced with Equation 5 below.

$${M}_{O} \ddot{x} + N + {F}_{f} = {F}_{p} + \hat{N} ( q , \dot{q} ) - {F}_{c}^{force} - {F}_{ext} \qquad [ Equation 5 ]$$

Here, Mₒ represents an actual mass matrix, “N” represents another non-linear item, and F_{f} represents a frictional force vector.

In Equation 5 above, the system models Mₒ and “N” may be refined to express the model uncertainty, and thus the model uncertainty closed-loop error dynamics may be expressed in Equation 6 below.

$${M}_{d} \ddot{e} + {D}_{d} \dot{e} + {K}_{d} e = {F}_{ext} + {M}_{d} {\hat{M}}_{O}^{- 1} ( {F}_{f} + Δ N + Δ {M}_{O} \ddot{x} ) \qquad [ Equation 6 ]$$

Here, e is an error between a position target value and an actual position (i.e., a position error), ė is a first derivative of the position error, ë is a second derivative of the position error, D_{d} is a damping target value, K_{d} represents a rigidity target value, ΔN represents an uncertainty of a non-linear item estimate value, and ΔMₒ represents an uncertainty of a mass matrix estimate value.

The error dynamics in Equation 6 include disturbances, such as the frictional force F_{f} and the model uncertainty (ΔN and ΔMₒ\ddot{x}).

According to the impedance-based robot motion control, an external force of error dynamics may ensure a low-impedance safe contact. However, the disturbances may have a negative influence on an impedance rendering performance. Accordingly, an additional control algorithm has to solve this problem by using a disturbance observer.

To this end, the robot control system 100 includes a work space force/acceleration disturbance observer 120 that considers both an interactive force and an acceleration.

The work space force/acceleration disturbance observer 120, unlike conventional work space disturbance observers, includes an external force loop in its nominal model. Accordingly, the work space force/acceleration disturbance observer 120 simultaneously ensures a robust motion control in free motion and a safe contact with the environment.

For the impedance-based robust motion control, the control input force has to be expressed in Equation 7 below.

$${F}_{c}^{′} = {F}_{p} - {F}_{c}^{force} - \hat{D} \qquad [ Equation 7 ]$$

Here, F′_{c} represents a control input force, Fₚ represents an impedance-based motion control input, F_{c}^{force} represents an external force, and \hat{D} represents a disturbance estimate value.

Furthermore, the final control input force Fc transmitted to the robot manipulator may be expressed in Equation 8 below.

$${F}_{c} = {F}_{c}^{′} + \hat{N} \qquad [ Equation 8 ]$$

\hat{N} represents an estimate value of another non-linear item including a Coriolis force and a gravitational force.

In Equation 7, the robot control system 100 regards an external force as a control purpose rather than a disturbance. Accordingly, the estimated disturbance of the disturbance observer 120 may be expressed in Equation 9 below.

$$\hat{D} = Q ( - {F}_{c}^{′} + {\hat{M}}_{O} \ddot{x} + {F}_{ext} ) \qquad [ Equation 9 ]$$

Here, “Q” represents a “Q” filter, \hat{M}ₒ represents a mass matrix estimate value, x represents an acceleration in the Cartesian coordinate system, and Fₑₓₜ represents an interactive force.

Referring to Equation 9, the external force is input to the “Q” filter. Accordingly, the interactive force exists in closed-loop impedance dynamics. Furthermore, by substituting Equation 7 and Equation 9 into Equation 2, closed loop dynamics may be obtained, and may be expressed in Equation 10 below.

$${\hat{M}}_{O} \ddot{x} = {F}_{p} - {F}_{ext} - {F}_{c}^{force} - ( I - Q ) ( Δ {M}_{O} \ddot{x} + {F}_{f} + Δ N ) \qquad [ Equation 10 ]$$

Here, “I” represents a unit matrix.

The error dynamics of Equation 10 in a frequency area of a cutoff frequency of the “Q” filter (low-pass filter) or less may be expressed in Equation 11 below.

$${\hat{M}}_{O} \ddot{x} = {F}_{p} - {F}_{ext} - {F}_{c}^{force} \qquad [ Equation 11 ]$$

Here, by substituting Equation 4 and Equation 12 below for impedance-based motion control input, the closed-loop impedance dynamics of the robot may be calculated in Equation 13 below.

$${\hat{M}}_{O} \ddot{x} = {F}_{p} - {F}_{ext} - {F}_{c}^{force} \qquad [ Equation 12 ]$$

$${M}_{d} \ddot{e} + {D}_{d} \dot{e} + {K}_{d} e = {F}_{ext} \qquad [ Equation 13 ]$$

According to this, because the disturbance observer 120 considers the external force for control purposes, the interactive force may be maintained according to setting of the target impedance, and thus, a safe contact may be ensured.

To describe the gist of the inventive concept, there are some unmentioned contents related to the system 100 illustrated in FIG. 1, but the implementation process and the operational effects thereof will be fully understandable to those skilled in the art.

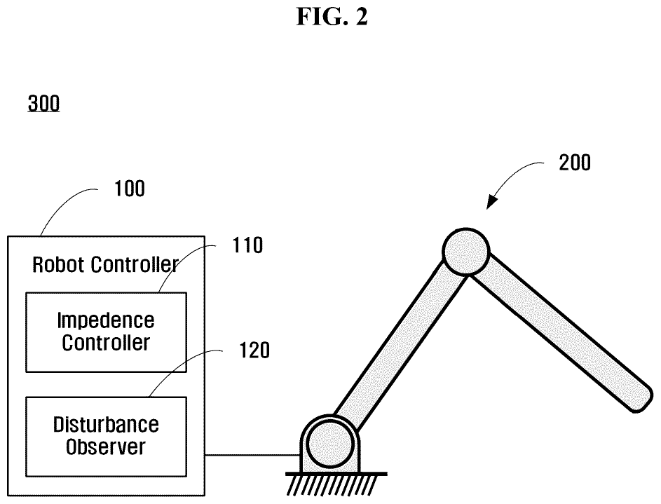

FIG. 2 is a view schematically illustrating a robot including a work space force/acceleration disturbance observer according to another embodiment of the inventive concept.

Referring to FIG. 2, the robot 300 includes a robot controller 100 and a robot manipulator 200.

The robot 300 according to the embodiment of the inventive concept may be a robot that performs an impedance-based motion control in a work space.

The robot controller 100 is connected to the robot manipulator 200 and controls a motion of the robot manipulator 200.

The robot controller 100 may be configured substantially the same as the robot control system described with reference to FIG. 1.

FIG. 2 illustrates the simplified robot manipulator 200, but the robot manipulator 200 is not limited thereto, and embodiments of the inventive concept include various robot manipulators, such as a horizontal or vertical multi-joint robot manipulator with an arbitrary degree of freedom, and an orthogonal robot manipulator, a scara robot manipulator, and a delta robot manipulator.

The robot 300 may include a force/torque sensor (an F/T sensor) (not illustrated) for measuring an interactive force.

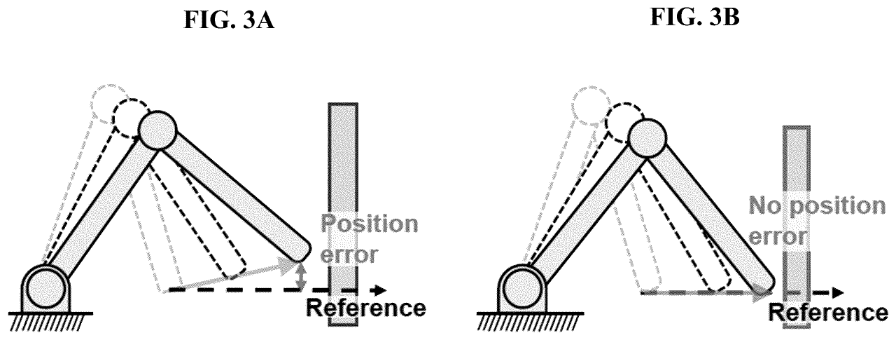

FIGS. 3A and 3B are views schematically illustrating performances of the robot of FIG. 2 in the free motion space.

Referring to FIGS. 3A and 3B, a result FIG. 3A of a motion of the robot by an impedance-based control and a result FIG. 3B of a motion of the robot including the work space force/acceleration disturbance observer according to the embodiment of the inventive concept are illustrated.

The free motion space refers to a condition, in which there is no contact between the robot and the external environment.

When only the impedance-based control is used, the error dynamics of Equation 6 above, which includes disturbances, such as a frictional force and a model uncertainty are followed. Because there is no error integration in this approach, a tracking performance is reduced due to frictions, and the model uncertainty has a similar influence. As a result, the disturbance of the error dynamics has a negative influence on the impedance rendering performance, and thus may cause position errors in the free motion space as illustrated in FIG. 3A.

This disorder may be solved by using additional control algorithms, such as the work space force/acceleration disturbance observer according to the embodiment of the inventive concept. According to the inventive concept, the work space force/acceleration disturbance observer removes the disturbance, and thus, a very precise tracking performance as illustrated in FIG. 3B may be ensured.

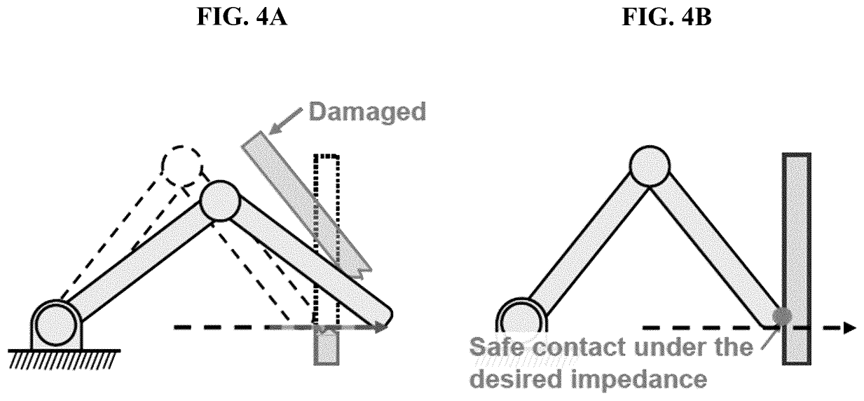

FIGS. 4A and 4B are views schematically illustrating performances of the robot of FIG. 2 in the contact motion space.

Referring to FIGS. 4A and 4B, the result FIG. 4A of the motion of the robot caused by a conventional work space disturbance observer and the result FIG. 4B of the motion of the robot including the work space force/acceleration disturbance observer according to the embodiment of the inventive concept are illustrated.

The contact motion space refers to a condition, in which there is a contact between the robot and the external environment.

When the conventional work space disturbance observer is used, the influence of the external forces on the error dynamics is eliminated, a potential damage to the robot or the environment due to interactive forces in contact situations may be caused. That is, the conventional work space disturbance observer may cause a damage to the environment as illustrated in FIG. 4A because it generates control inputs only to reduce errors without considering safety or tracking.

This disorder may be solved by using the work space force/acceleration disturbance observer according to the embodiment of the inventive concept. According to the inventive concept, because the work space force/acceleration disturbance observer considers the external force for control purposes, the interactive force is maintained according to the setting of the impedance target value, and thus, a safe contact may be ensured as illustrated in FIG. 4B.

According to the disclosed embodiment, the disturbance observer loop is designed by considering both the interactive force and the acceleration, and thus, precise motion tracking is possible even at setting of a low impedance gain.

According to the disclosed embodiment, a safe contact is possible while maintaining a low impedance through an excellent impedance rendering performance.

Although the exemplary embodiments of the inventive concept have been described with reference to the accompanying drawings, it will be understood by those skilled in the art to which the inventive concept pertains that the inventive concept can be carried out in other detailed forms without changing the technical spirits and essential features thereof. Therefore, the above-described embodiments are exemplary in all aspects, and should be construed not to be restrictive.

What is claimed is:

1. A work space force/acceleration disturbance observer connected to an impedance-based motion controller in a work space, and configured to acquire a disturbance estimate value in consideration of an interactive force and an acceleration applied to an end effector of a robot, wherein
the disturbance estimate value is expressed in Equation 1 below,
$$\hat{D} = Q ( - {F}_{c}^{′} + {\hat{M}}_{O} \ddot{x} + {F}_{ext} ) \qquad [ Equation 1 ]$$
wherein \hat{D} is the disturbance estimate value, “Q” is a “Q” filter, F′_{c} is a control input force, M̅ₒ is a mass matrix estimate value, \ddot{x} is the acceleration, and Fₑₓₜ is the interactive force.

2. The work space force/acceleration disturbance observer of claim 1, wherein the control input force is expressed in Equation 2 below,
$${F}_{c}^{′} = {F}_{p} - {F}_{c}^{force} - \hat{D} \qquad [ Equation 2 ]$$
wherein Fₚ is an impedance-based motion control input by the impedance-based motion controller, and F_{c}^{force} is an external force.

3. The work space force/acceleration disturbance observer of claim 2, wherein a final control input force F_{c} transmitted to a robot manipulator is expressed in Equation 3 below,
$${F}_{c} = {F}_{c}^{′} + \hat{N} \qquad [ Equation 3 ]$$
wherein \hat{N} is an estimate value of another non-linear item including a Coriolis force and a gravitational force.

4. The work space force/acceleration disturbance observer of claim 2, wherein the external force is expressed in Equation 4,
$${F}_{c}^{force} = ( {\hat{M}}_{O} {M}_{d}^{- 1} - 1 ) {F}_{ext} \qquad [ Equation 4 ]$$
wherein \hat{M}ₒ is the mass matrix estimate value, and M_{d} is a mass target value.

5. The work space force/acceleration disturbance observer of claim 2, wherein the impedance-based motion control input is expressed in Equation 5 below,
$${F}_{p} = {\hat{M}}_{O} {\ddot{x}}_{d} + {\hat{M}}_{O} {M}_{d}^{- 1} ( {D}_{d} \dot{e} + {K}_{d} e ) \qquad [ Equation 5 ]$$
wherein \hat{M}ₒ is the mass matrix estimate value, \ddot{x}_{d} is an acceleration target value, M_{d} is a mass target value, e is a position error, ė is a first derivative of the position error, D_{d} is a damping target value, and K_{d} is a rigidity target value.

6. The work space force/acceleration disturbance observer of claim 5, wherein closed loop dynamics is expressed in Equation 6 below,
$${\hat{M}}_{O} \ddot{x} = {F}_{p} - {F}_{ext} - {F}_{c}^{force} - ( I - Q ) ( Δ {M}_{O} \ddot{x} + {F}_{f} + Δ N ) \qquad [ Equation 6 ]$$
wherein \hat{M}ₒ is the mass matrix estimate value, \ddot{x} is the acceleration, “I” is a unit matrix, ΔMₒ is an uncertainty of the mass matrix estimate value, F_{f} is a frictional force, and ΔN is an uncertainty of a non-linear item estimate value including a Coriolis force and the gravitational force.

7. The work space force/acceleration disturbance observer of claim 6, wherein the closed loop dynamics in a frequency area of a cutoff frequency of the “Q” filter or less is expressed in Equation 7 below,
$${\hat{M}}_{O} \ddot{x} = {F}_{p} - {F}_{ext} - {F}_{c}^{force} . \qquad [ Equation 7 ]$$

8. The work space force/acceleration disturbance observer of claim 7, wherein the closed loop dynamics is expressed in Equation 8 below,
$${M}_{d} \ddot{e} + {D}_{d} \dot{e} + {K}_{d} e = {F}_{ext} \qquad [ Equation 8 ]$$
wherein M_{d} is the mass target value, e is the position error, ė is the first derivative of the position error, ë is a second derivative of the position error, D_{d} is the damping target value, and K_{d} is the rigidity target value.

9. A robot for performing an impedance-based motion control in a work space, the robot comprising:
a robot manipulator; and
a robot controller connected to the robot manipulator,
wherein the robot controller includes an impedance-based motion controller, and a work space force/acceleration disturbance observer connected to the impedance-based motion controller,
wherein the work space force/acceleration disturbance observer acquires a disturbance estimate value in consideration of an interactive force and acceleration applied to an end effector of the robot, and
wherein the disturbance estimate value is expressed in Equation 9 below,
$$\hat{D} = Q ( - {F}_{c}^{′} + {\hat{M}}_{O} \ddot{x} + {F}_{ext} ) \qquad [ Equation 9 ]$$
wherein \hat{D} is a disturbance estimate value, “Q” is a “Q” filter, F_{c}′ is a control input force, \hat{M}ₒ is a mass matrix estimate value, \ddot{x} is the acceleration, and Fₑₓₜ is the interactive force.
